(19) United States
(12) Patent Application Publication
(10) Pub. No.: US 2004/0090889 A1
(43) Pub. Date: May 13, 2004

(54) Recording pulse generator

(75) Inventors: Isao Okada, Kyoto-shi (JP); Tsuyoshi Hirabuki, Kyoto-shi (JP); Noriyuki Kotani, Kyoto-shi (JP)

Correspondence Address: SUGHRUE MION, PLLC, 2100 PENNSYLVANIA AVENUE, N.W., SUITE 800, WASHINGTON, DC, 20037, US

(73) Assignee: ROHM CO., LTD.

(21) Appl. No.: 10/693,928

(22) Filed: Oct. 28, 2003

(30) Foreign Application Priority Data
Nov. 1, 2002 (JP) 2002-320476

(51) Int. Cl. G11B 7/0045

(52) U.S. Cl. 369/47.28

(57) ABSTRACT

The recording pulse generator performs plural signal processing with one delay line, with regard to the control of recording signals in writing pit data onto the surface of a disk. The recording pulse generator includes a first delay line connected to the common power supply line with a PLL oscillator having a second delay line, having plural circuit elements equivalent to the second delay. line cascaded in multiple stages, a means that generates plural clocks each having different phase differences with a clock inputted to the first stage, according to the number of stages of the plural circuit elements of the first delay line, a means that selects an arbitrary clock from plural clocks generated, and a recording pulse generation means that generates a recording pulse whose pulse width is controlled on the basis of a clock selected.

### BACKGROUND OF THE INVENTION

1. Field of the Invention

The present invention relates to a recording pulse generator capable of controlling the original data with a. necessary resolution for implementing the write strategy (hereinafter referred to as WS), which is the time resolution management function for compensating the on-off time of a laser (the run length of data) in the thermal recording of data onto a CD-R/RW or a DVD.

2. Description of the Related Art

Data writing onto a CD-R/RW or a DVD is performed through the thermal recording by a laser onto the surface of a. disk, which accompanies the change of a pigment on the surface, or crystallization or non-crystallization (“0” or “1”) of the surface. In practice, when a pit data with a predetermined length is supplied to a LDD (Laser Diode Driver) as it is, the pit data will not be recorded to meet a desired form. Accordingly, there arose the WS as the correction function for recording a pit data as much approximate to the desired pit data as possible, by controlling the on-off time of a laser (the run length of data) in the thermal recording, which is generally known.

Though the invention relates to a recording pulse generator capable of controlling the original data with a necessary resolution for implementing the WS, before it is described, the method of writing data onto the surface of a disk will be explained first.

The thermal recording by a laser onto the surface of a disk will allow recording of a precise run length of data, by considering the on-off time of the laser and the thermal distribution of the disk surface.

The WS is a function for correcting the emission of a laser diode, in order to enhance the recording accuracy of the run length of data. An operation example thereof will be shown.

FIG. 8 shows an idealistic write state, when a pit data (“1”) with a length of 3T is written, in which FIG. 8(a) illustrates the pit data to be recorded, and FIG. 8(b) illustrates the pit data after recorded.

In the idealistic state, the pit data with a length of 3T as illustrated in FIG. 8(a) will be recorded on the disk surface in a form illustrated in FIG. 8(b).

In reality however, when the pit data with a length of 3T to be formed on the disk surface is supplied to an LDD (Laser Diode Driver) as it is, the rise and fall of the output will be distorted.

FIG. 9 recounts the data writing onto the disk in this case. FIG. 9(a) illustrates a waveform of the pit data to be recorded. This pit data is supplied as it is to the LDD as the first input signal. FIG. 9(b) illustrates a signal waveform thereof. Naturally, it is the same waveform as the pit data, which is synchronized therewith. FIG. 9(c) illustrates the second input signal to the LDD (here, it remains the state of LOW). FIG. 9(d) illustrates a thermal distribution of the disk surface by the laser that is practically outputted on the basis of the first and second input signals. FIG. 9(e) illustrates the pit data having been recorded on the disk surface. The shape of the pit data is clearly collapsed, compared with the idealistic pit data illustrated in FIG. 8(b). The quality of the pit data is not very good in this manner, and there are some potentialities of the pit data being recognized as a wrong data.

This results from the delay of the response of the laser diode in the LDD and the delay of the thermal transmission (distribution) of the disk surface. If a signal with a time length intact is supplied to the LDD to synchronize with the pit data to be recorded, the pit data will have a shape as FIG. 9(e); accordingly, it will be necessary to correct these by means of the WS.

FIG. 10 explains the method of writing a pit data onto a disk surface through a correction by the WS.

In this recording method, with regard to the pit data as illustrated in FIG. 10(a), the rise and fall of an input signal 1 to the LDD are shifted to earlier times than the rise and fall of the pit data, in consideration for the thermal response time of the disk surface, as illustrated in FIG. 10(b). At the same time, a signal 2 is given a correction of adding a pulse signal for overwriting, as illustrated in FIG. 10(c), in order to make the rise of the LDD sharp and compensate the delay of the thermal transmission on the recording surface directly after the rise.

And, when the correction signals for writing the pit data with a length of 3T onto the disk surface are supplied to the LDD, the laser output having a shape as FIG. 10(d) will be attained.

Thereby, an improved pit data as illustrated in FIG. 10(e) is recorded on the disk surface, and it is recognized as a correct pit data.

FIG. 11 illustrates waveforms to be controlled, when an EFM data controlled by an EFM clock is written onto a CD-R and CD-RW.

FIG. 11(a) shows the waveform of the EFM clock data. FIG. 11(b) shows the waveform of the EFM data, which has the time period 5T in HIGH, the following 3T in LOW, and the next 3T in HIGH. FIG. 11(c) illustrates a laser output when the waveform of the EFM data in FIG. 11(b) is applied to the LDD of the CD-R; and FIG. 11(d) illustrates a laser output when the waveform of the same is applied to the LDD of the CD-RW. It is found that both cases correct writing within the time period less than 1T of the EFM clock, concretely, 1/16 of the same, or correct cooling level, erase level, or write level.

Thus, in order to perform a correct recording through corrections by the WS, it is necessary to control the original signal with a resolution less than 1/16 of the period T of each recording speed.

FIG. 12 is a mathematical table showing the EFM clock, T (period: 1/EFM clock), and T/16 in correspondence with the actual recording speed. This table clearly shows that the recording of the CD-R48x requires the time control in a unit of at least 0.3 ns, namely, 300 ps from the values of T/16 in FIG. 12.

The foregoing corrections differ depending on the types of the disks, the writing speeds (double speed), the types of the LDD; and the WS is required to make the corrections of time in compliance with the characteristics of the above factors.

Next, a conventional recording pulse generator will be described with reference to FIG. 13, which, though it is not known as a prior art document, attains corrected recording pulses through the foregoing time control by the WS.

The conventional recording pulse generator includes a PLL oscillator 1, a delay line 11, a system clock (reference clock) generator 12, and a controller not illustrated, and a selector 20, etc. The system clock generator 12 here is made up with a crystal oscillator and so forth, and the oscillation frequency thereof is hardly affected by the external change of environmental conditions. The PLL oscillator 1 receives a system clock CLK (hereunder, mentioned as clock CLK) from the system clock generator 12 to oscillate a frequency locked with the oscillation frequency of the system clock generator 12, and outputs a supply voltage signal to set operational delay times to inverter elements of the delay line 11. The PLL oscillator 1 includes a VCO 2, a counter 3 being a 1/N frequency divider, a phase comparator 4, a low pass filter 6, a voltage follower 7, a counter 8 being a 1/M frequency divider.

And, a control voltage Vs applied to the VCO 2 is assigned to the above voltage signal applied to the delay line 11.

The VCO 2 is a ring oscillator in which the output of cascaded inverters 2a, 2a, 2a, . . . is fed back to the input thereof. In the same manner, the delay line 11 is configured with inverters 2b, 2b, 2b, . . . cascaded in plural stages. The inverters 2b, 2b, 2b, . . . are equivalent to the inverters 2a, 2a, 2a, . . . , which are integrated into one and the same IC. The control voltage Vs is supplied as the supply voltages applied to each of the inverters 2a and 2b, and the operational delay time of one inverter varies according to the values of the supply voltages. Therefore, when the supply voltages applied to these inverters are equal, the operational delay time for one inverter becomes equal. In the PLL oscillator 1, the control voltage Vs as the supply voltages to both of the inverters 2a and 2b is controlled so as to coincide with the frequency of the clock CLK of the system clock generator 12, or a frequency having the frequency multiplied by a predetermined coefficient. That is, in the PLL oscillator 1, the output frequency of the VCO 2 is divided into 1/N the frequency by the counter 3 being the 1/N frequency divider, which is supplied to one input of the phase comparator 4, and the clock frequency of the system clock generator 12 is divided into 1/M the frequency by the counter 8 being the 1/M frequency divider, which is supplied to another input of the phase comparator 4. In the phase comparator 4, 1/N the output frequency inputted to one input is compared in the phase with 1/M the clock frequency inputted to another input.

The output signal of the phase comparator 4 is supplied to the LPF 6, where it is smoothed; the smoothed output is delivered to the voltage follower 7. Accordingly, the voltage follower 7 generates the control voltage Vs for locking the oscillation frequency of the VCO 2 with the frequency of the clock CLK, or for controlling to bring it in coincidence in a predetermined frequency scale.

In this manner, by using the output of the voltage follower 7 to drive the oscillator, which is used as the power supply line that determines the operational voltages of the inverters 2a and 2b constituting the delay line, and inputting the control voltage signal that controls the frequency to the input side of the voltage follower 7 through the (LPF) 6, it is possible to provide the VCO 2 (ring oscillator) with the power supply of the voltage Vs equal to the control voltage of the input side of the voltage follower 7 and lock the oscillation frequency of the VCO 2 with the frequency of the clock CLK. As the result, the oscillation frequency of the PLL oscillator 1 is controlled and locked so as to coincide with the frequency of the system clock generator 12, in the scales corresponding to the frequency dividing ratios 1/N and 1/M of the counter 3 and counter 8.

The control voltage Vs at this moment becomes constant, since the operational delay time of one inverter 2a is determined in accordance with the frequency of the system clock generator 12. This is the same with the inverter 2b that receives the same control voltage Vs and operates with it, which is because the inverter 2b is the element of the delay line 11 integrated into the same IC together with the inverter 2a. Now, provided that the delay time per one inverter 2b is given by t, and the number of cascaded stages is given by p, the delay time of the delay line 11 is calculated as t×p, to the input signal (EFMDATA-1T) at the input terminal thereof.

The numeric symbol 20 in FIG. 13 denotes a selector, and it receives the clocks having the above time difference from 16 taps 11a provided for each two stages of the inverter 2a of the delay line 11. The clocks are selected by a selection means 21, and the selected clocks pass through a level shifter 22, which are inputted to one input of an OR circuit 23, and to another input of the OR circuit 23 is supplied the EFMDATA-1T, thus the recording pulses are to be delivered from the OR circuit 23.

In the foregoing conventional recording pulse generator, the voltage generated by the VCO 2 of the PLL oscillator 1 is supplied to the delay line 11, the EFMDATA-1T illustrated in FIG. 14(2) is inputted to the input terminal of the delay line 11, and the signals having different phases for each two stages of inverters are outputted from the taps for generating delay signals T′0˜T′15. And, the original signal EFMDATA-1T and the delay signals T′0˜T′15 are used to perform the signal control with the resolution of 8.00˜900 ps.

FIG. 14 illustrates the pulse waveforms of the conventional recording pulse generator as shown in FIG. 13.

FIG. 14(1) shows the waveform of the EFMDATA, and FIG. 14(2) shows the waveform of the EFMDATA-1T shorter by 1T than the EFMDATA, which is derived from the EFMDATA. FIG. 14(3) shows the waveform at the output of the selector 20, when the EFMDATA-1T is applied to the input stage of the delay line 11 in FIG. 13, and the delayed data having a predetermined time difference (phase difference) is attained as a selector output. And, FIG. 14(4) shows the waveform of the recording pulse obtained by the OR circuit 23 taking the logical sum of the pulses as shown in FIG. 14(2) and FIG. 14(3).

As described above, in the conventional recording pulse generator, the original signal being a time-controlled object is inputted to the delay line 11, and the delay signal of the original signal and the original signal are used to vary the original signal; therefore, it is impossible to process plural signals by one delay line 11. That is, since the input of the delay line 11 is the pulse of the EFMDATA-1T being shorter by 1T (one clock cycle), plural recording pulses cannot be generated in principle. For example, when a certain recording pulse T′1 is selected, the other recording pulse T′2 cannot be selected in the same recording cycle. That is, the conventional recording pulse generator requires one delay line for one signal control; accordingly, the control of plural signals needs as many delay lines as the number of the control signals, thus leading to a problem of increasing the chip size.

Further, the conventional recording pulse generator is difficult to control complicated signals, and is incapable of generating the recording pulse shorter than the clock cycle that gives the timing to switch the selector 20.

With regard to the present invention, any disclosed document of the prior art was not found.

### SUMMARY OF THE INVENTION

The present invention has been made in view of the above problems, and through inputting the EFMCLK (Eight to Fourteen Modulation Clock) to the delay line and generating clocks with the EFMCLK subdivided into 1/16, it intends to freely vary the run length of the EFM data by means of a signal generator composed of a multiplexer and flip-flops, etc. That is, it intends to implement plural signal processing with one delay line, by using the delay line in common and only increasing the number of the recording pulse generator as needed.

A first aspect of the invention is a recording pulse generator comprising a first delay line having plural circuit elements cascaded in multiple stages, a means that generates plural fine clocks each having different phase differences with a clock inputted to the first stage of the first delay line, according to the number of stages of the plural circuit elements thereof, a means that selects an arbitrary fine clock from plural fine clocks generated, and a recording pulse generation means that generates a recording pulse on the basis of a fine clock selected.

A second aspect of the invention is a recording pulse generator in the first aspect of the invention, further comprising a PLL oscillator that possesses an oscillator with plural circuit elements cascaded in multiple stages, compares the phase of a signal generated by the oscillator with the phase of the clock inputted to the first stage, and controls a voltage of a power supply line according to the phase comparison result, wherein the first delay line is connected to the common power supply line with the oscillator, and the circuits elements of the first delay line are equivalent to the circuit elements of the oscillator.

A third aspect of the invention is a recording pulse generator in the first or second aspect of the invention, wherein the clock inputted to the first stage of the first delay line is an EFM clock that varies according to a recording speed.

A fourth aspect of the invention is a recording pulse generator in the first to third aspects of the, wherein the clock selection means is a multiplexer controlled by selection signals shifted in the same phase with the fine clocks.

A fifth aspect of the invention is a recording pulse generator in any of first to fourth aspects of the invention, wherein the recording pulse generation means is provided with a flip-flop circuit that operates based on a delayed clock selected by the multiplexer.

### BRIEF DESCRIPTION OF THE DRAWINGS

FIG. 1 illustrates a recording pulse generator relating to the first embodiment of the invention;

FIG. 2 illustrates one example of clocks attained by the delay line of the recording pulse generator illustrated in FIG. 1;

FIG. 3 illustrates one example of the clocks inputted to FF by varying the clocks in FIG. 2;

FIG. 4 illustrates a configuration of the recording pulse generator relating to the first embodiment;

FIG. 5 is a timing chart showing the operation example of the recording pulse generator in FIG. 4;

FIG. 6 shows the contents of the signals in the timing chart illustrated in FIG. 5;

FIG. 7 illustrates simulated waveforms of the fine clocks;

FIG. 8 typically illustrates an idealistic write example when a pit data is written onto the surface of a disk, in which FIG. 8(a) illustrates the pit data to be recorded, and FIG. 8(b) illustrates the pit data after recorded;

FIG. 9 typically illustrates a practical write example when a pit data is written onto the surface of a disk, .in which FIG. 9(a) illustrates a waveform of the pit data to be recorded, FIG. 9(b) a signal waveform of a signal 1 to the LDD, FIG. 9(c) a signal waveform of a signal 2 to the LDD, FIG. 9(d) a thermal distribution of the disk surface by. a laser-power outputted on the basis. of the signals 1 and 2, and FIG. 9(e) the pit data after recorded;

FIG. 10 typically explains the method of writing a pit data onto a disk surface through a correction by the WS, in which FIG. 10(a) illustrates the pit data, FIG. 10(b) an input signal 1 to the LDD whose rise and fall are shifted to earlier times than those of the pit data, FIG. 10(c) a signal 2 to the LDD being given a correction of adding a pulse signal for overwriting, FIG. 10(d) a thermal distribution of the disk surface by a laser power outputted on the basis of the signals 1 and 2, and FIG. 10(e) the pit data having been recorded in practice;

FIG. 11 explains a practical write example when the WS is carried out in the recording of the EFM data, in which FIG. 11(a) shows the waveform of the EFM clock, FIG. 11(b) the waveform of the EFM data, FIG. 11(c) a laser power output when the waveform of the EFM data in FIG. 11(b) is applied to the LDD of a CD-R, and FIG. 11(d) a laser power output when the waveform of the same is applied to the LDD of a CD-RW;

FIG. 12 is a mathematical table showing the relation of the EFM clock, T (period), and T/16;

FIG. 13 illustrates a configuration of a conventional recording pulse generator; and

FIG. 14 illustrates the pulse waveforms of the conventional recording pulse generator in FIG. 13, in which FIG. 14(1) shows the waveform of the EFMDATA, FIG. 14(2) the waveform of the EFMDATA-1T shorter by 1T than the EFMDATA, FIG. 14(3) the waveform of the selector output, and FIG. 14(4) the waveform of the recording pulse at the output of the OR circuit.

### DETAILED DESCRIPTION OF THE PREFERRED EMBODIMENTS

The first embodiment of the invention will be described in detail with reference to the accompanying drawings.

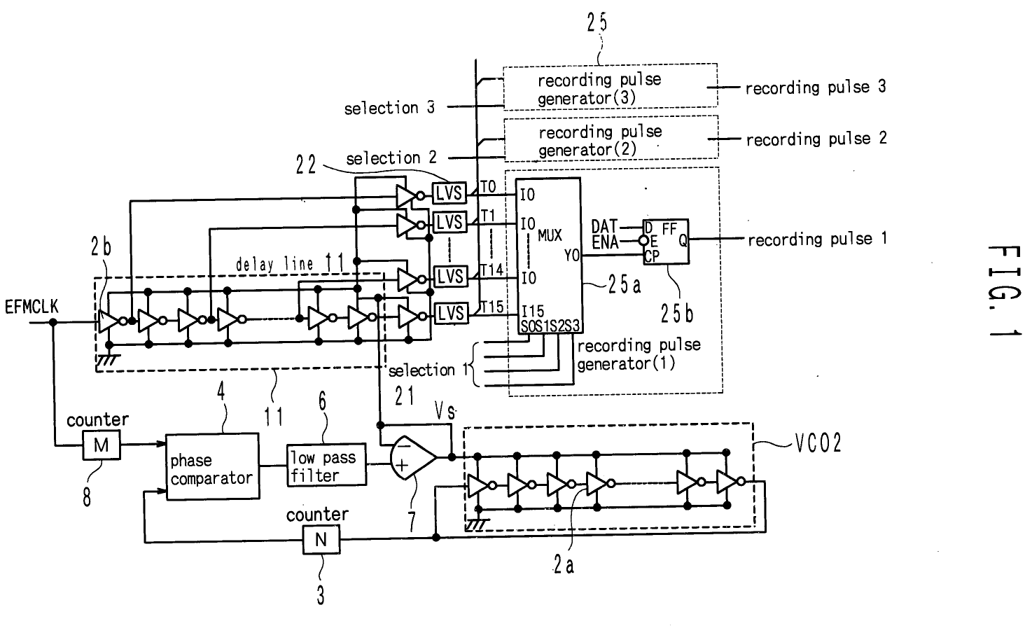

FIG. 1 illustrates the recording pulse generator relating to the first embodiment of the invention.

This recording pulse generator performs a resolution control in real time within 1/16 time of the EFMCLK in correspondence with the frequency of the EFMCLK (EFM clock), in order to realize the WS that varies the recording pulse width in real time according to the recording .pulse length with a fine resolution required in the recording of a CD-R/RW and DVD.

In the drawing, the same components as in the conventional recording pulse generator are given the same numbers, and the descriptions on the same components will be omitted here.

Although the conventional recording pulse generator implements the OR operation of the selected clock from the delay line 11 and the EFMDATA-1T to attain the recording pulse, the recording pulse generator of this embodiment delays the EFMCLK by the delay line 11, namely, generates a delayed signal (fine clock) of the EFMCLK by utilizing the ring oscillator VCO composed of the inverter 2b,as described above, and controls a recording pulse generator 25 by the signal (fine clock) to generate a recording pulse.

Concretely, the recording pulse generator supplies the control voltage Vs of the VCO 2 of the PLL oscillator 1 to the delay line 11 composed of the inverter string equivalent to the VCO 2, and attains the fine clocks T0˜T15 having a predetermined time difference from 16 taps provided for each two stages of the inverter.

As already described, the time difference between these clocks depends on the oscillation frequency of the VCO 2, and by setting the frequency dividers 3 and 8 composed of the counters in the drawing to synchronize with the oscillation frequency of the VCO 2, the fine clocks T0˜T15 of 1/16 time of. the EFMCLK can be obtained as desired.

Selecting the fine clocks T0˜T15 by a multiplexer (MUX) 25a of the recording pulse generator 25 illustrated in FIG. 1, supplying the selected clock to a post-stage flip-flop 25b will make it possible to control the signal with the resolution of 1/16 time of the EFMCLK.

As it is clear from FIG. 1, in case of controlling plural signals, it is possible to generate different delayed pulses only by increasing the number of the recording pulse generator 25. In other words, controlling the multiplexer (MUX) 25a by the selection signal shifted in the same phase with the fine clocks will select one of the fine clocks T0˜T15. And, supplying the selected arbitrary fine clock to. the flip-flop 25b will generate the recording pulse being programmable with fine resolution.

Here, the recording pulse is not limited to one, each of the recording pulse generators 25 is capable of generating plural recording pulses 1, 2, 3, . . . , and setting the pulse widths individually independently.

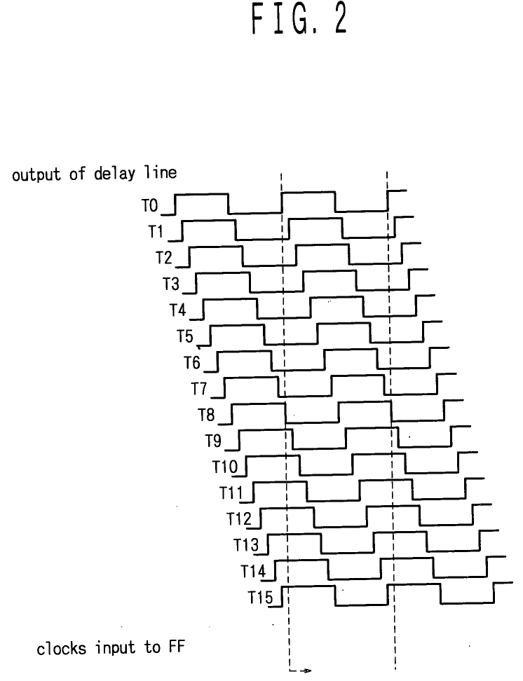

FIG. 2 illustrates one example of fine clocks T0˜T15 attained by making the output of the delay line 11 experience the level shifters 22.

As this example shows, the delay line 11 outputs the 16 fine clocks T0˜T15, which are made by shifting the EFMCLK each by T/16.

Next, supplying the selection signal to the MUX 25a at an appropriate timing will select a specified fine clock from the 16 fine clocks, and the selected fine clock will operate the FF (flip-flop) 25b.

Here, the delay times from the inputs to the outputs of the 16 channels of the MUX 25a are made equal between the channels for a practical use.

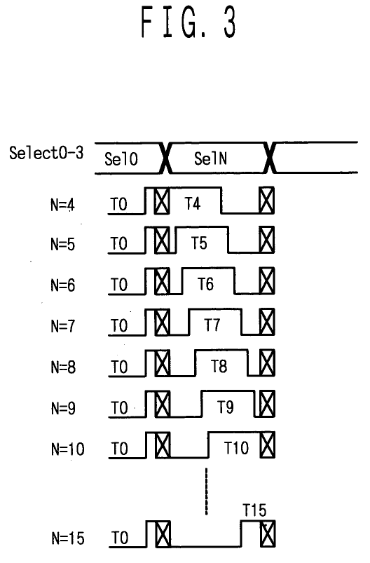

FIG. 3 illustrates the clock input to the FF (flip-flop) 25b.

This chart shows the state that the clock input to the FF connected to the MUX 25a varies when the selection signal (Select signal) of the MUX (16-channel multiplexer) 25a is switched by the fine clock T0. When switched by the fine clock T0, and the selection signal is set to 4˜15, this example shows to obtain the input fine clocks T4˜T15 whose rises and falls are shifted each by T/16, as illustrated in the drawing.

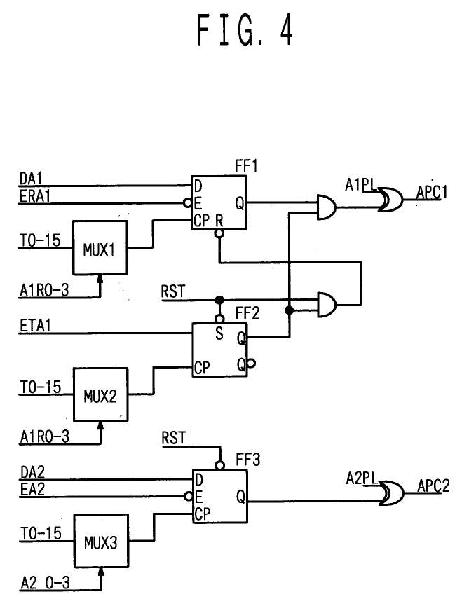

FIG. 4 illustrates a circuit configuration of the practical recording pulse generators (1) and (2). In this case, the fine clocks T0˜T15 each are inputted to the three MUX 1 through MUX 3, and the corresponding FF 1 through FF 3 are made to be able to independently select the fine clocks T0˜T15.

For example, in the uppermost FF 1, the MUX 1 is given a clock selection signal AIR 0-3 (APC1 Leading CLK Select signal: the rise clock selection signal for the first recording pulse output) to select an arbitrary clock from the fine clocks T0˜T15, and being given a data signal DA1 (APC1 Leading data: the rise data signal for the first recording pulse output) and an enabling signal ERA1 (APC1 Leading Enable signal: the rise enabling signal for the first recording pulse) at appropriate timing, the FF 1 operates at the timing of a selected fine clock, and generates the first recording pulse output (APC1).

Since the other FF 2 and 3 can be made operational on the same principle, it is possible to provide all the recording pulses of plural channels with the resolutions of the fine clocks to generate recording pulses each.

Here, the signals except for the fine clocks (T0˜T15) are designed to enter from a digital control circuit not illustrated.

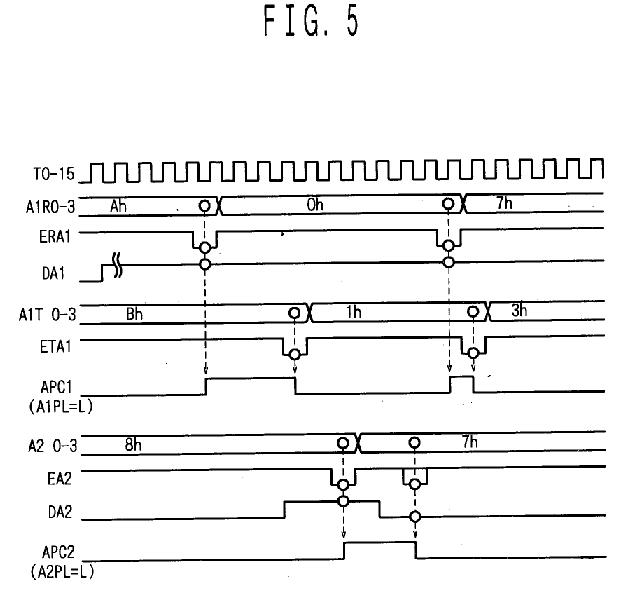

FIG. 5 is a timing chart showing the operation example of the recording pulse generator in FIG. 4. Although the fine clocks (T0˜T15) are the signals of 16 clocks, in the drawing, these are represented by one fine clock T0.

In the drawing, AIR 0˜3 signifies the selection signal for the first recording pulse output (APC1) of the MUX 25a, namely, the rise clock selection (Leading CLK Select) signal for the first recording pulse output (APC1), ERA1 the rise enabling (Enable) signal (Low active) for the first recording pulse output (APC1), DA1 the rise data (Leading data) for the first recording pulse output (APC1), AIT 0˜3 the fall clock selection (Trailing CLK Select) signal for the first recording pulse output (APC1), ETAL the fall enabling (Trailing Enable) signal (Low active) for the first recording pulse output (APC1), A2 0˜3 the clock selection (CLK Select) signal for the second recording pulse output (APC2), EA2 the enabling (Enable) signal (Low active) for the second recording pulse output (APC2), and DA2 the data for the second recording pulse output (APC2).

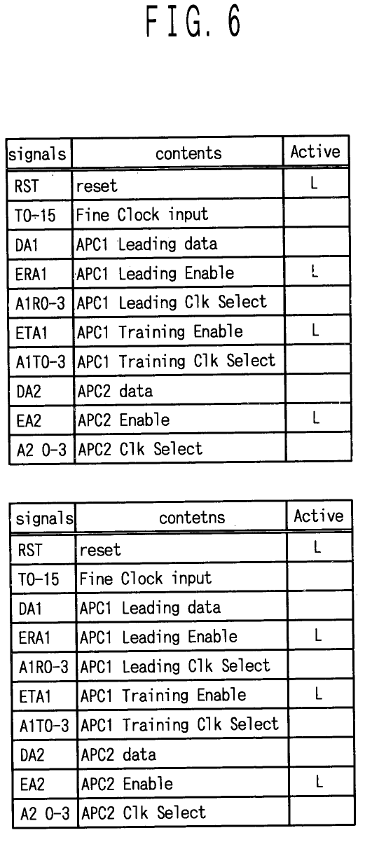

FIG. 6 puts the abovementioned signals together in one table.

In the recording pulse generator of this embodiment, based on the rise clock selection (Leading CLK Select) signal for the first recording pulse output (APC1) with the fine clock (T0˜T15), the first recording pulse output (APC1) rises at the timing that the rise enabling (Leading Enable) signal ERAL becomes active (Low). And, based on the fall clock selection (Trailing CLK Select) signal (AIT 0˜3) for the first recording pulse output (APC1), the first recording pulse output (APC1) falls at the timing that the fall enabling (Trailing Enable) signal ETAL becomes active (Low).

Further, based on the clock selection (CLK Select) signal A2 0˜3 for the second recording pulse output (APC2), the second recording pulse output (APC2) rises at the timing that the enabling (Enable) signal EA2 becomes active (Low), and the second recording pulse output (APC2) falls at the timing that the enabling (Enable) signal EA2 for the second recording pulse output (APC2) becomes active (Low) again.

Thus, correcting the original data with the fine clocks T0˜T15 will generate the recording pulse corrected by the WS.

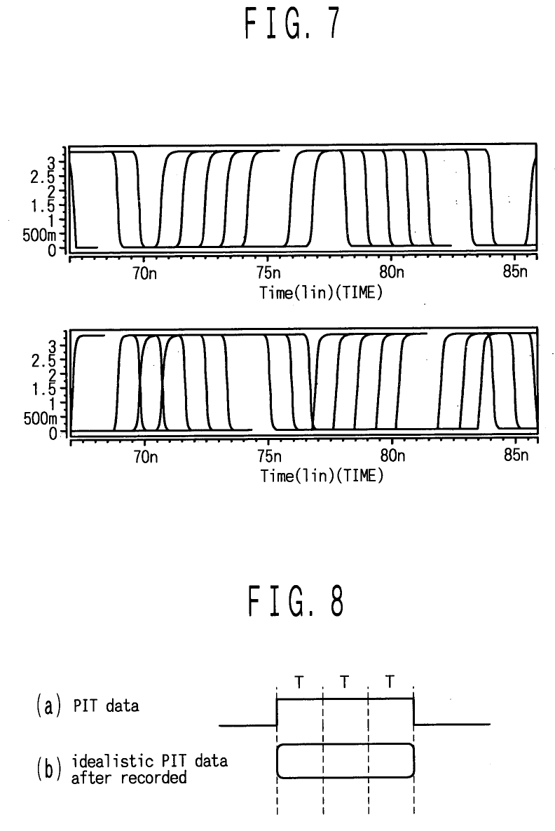

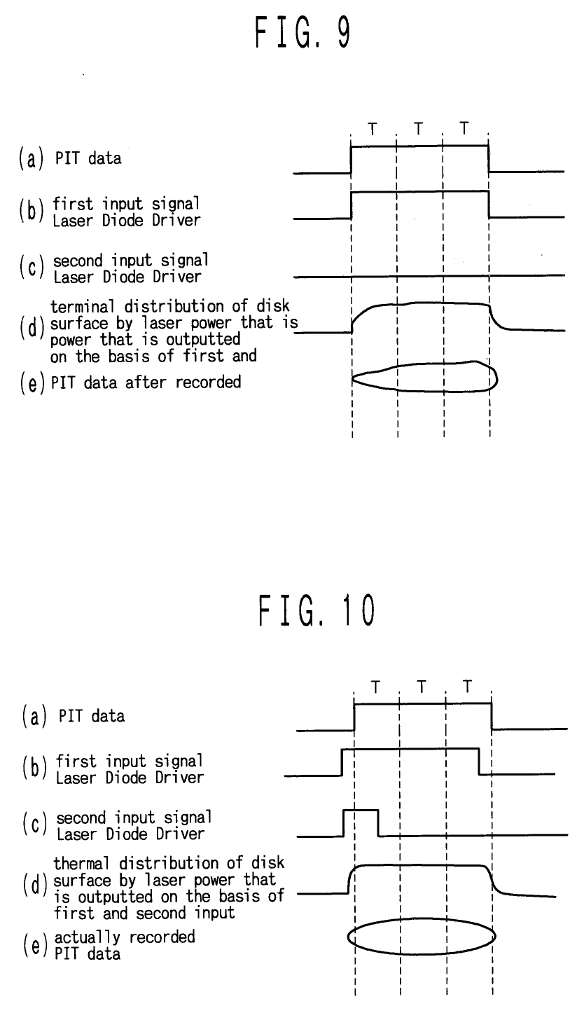

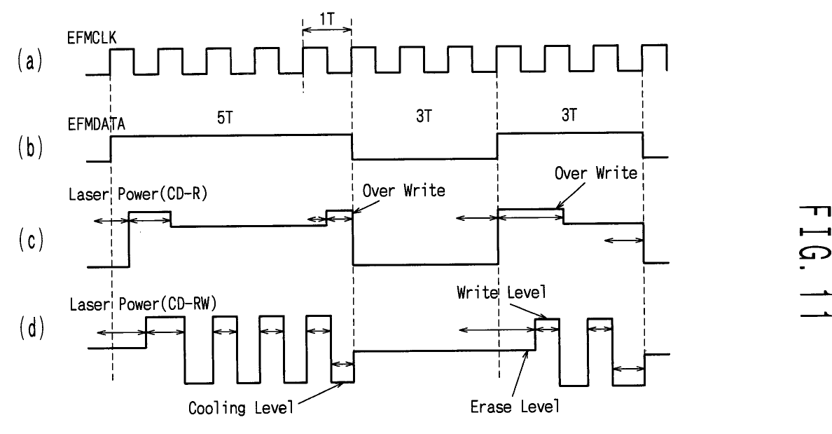

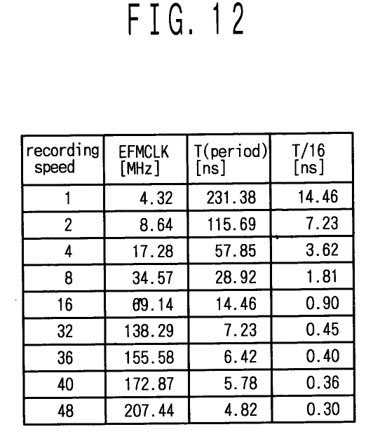

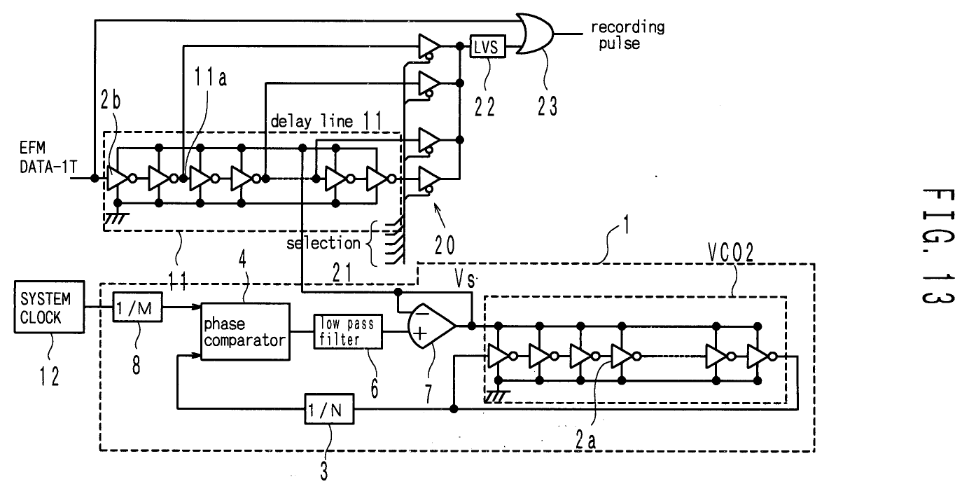

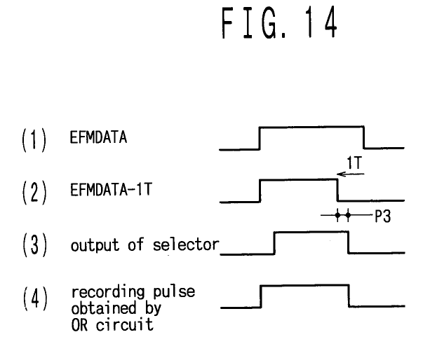

FIG. 7 illustrates simulated waveforms of the fine clocks T0˜T15 for a reference. These waveforms are the same as those observed in the IC chip, since the network after the layout is used.

In the above construction, the resolution of the fine clock can be enhanced to the limit of the operational speeds of the gates constituting the delay line. Further, a combination of the edges of the fine clock and the flip-flop will generate a complicated output waveform.

According to the invention, it is possible to arbitrarily set the resolution of the fine clock (T0˜T15) within a specified range (for example, 1.8 ns˜300 ps). It is also possible to easily enhance the resolution by, for example, increasing the number of stages of the inverters constituting the delay line, which makes it possible to generate a narrow pulse (for example, pulse width of 3 ns˜4 ns). Therefore, the oscillator does not need to use a high frequency band oscillator (giga-Hertz band). Or, it is easy to generate the write pulse train.

In addition to the capability of easily generating the recording pulses of plural channels, in writing a pit data onto a disk, the frequency of the EFM clock automatically varies according to the diameter of the disk in such a manner that the recording density becomes always constant on the disk, and at the same time, the fine clock automatically follows the variation of the EFM clock, thus permitting a generation of a complicated output waveform.

What is claimed is:

1. A recording pulse generator comprising:
a first delay line having plural circuit elements cascaded in multiple stages;
a means that generates plural fine clocks each having different phase differences with a clock inputted to the first stage of the first delay line, according to the number of stages of the. plural circuit elements thereof;
a means that selects an arbitrary fine clock from plural fine clocks generated; and
a recording pulse generation means that generates a recording pulse on the basis of a fine clock selected.

2. A recording pulse generator as claimed in claim 1, further comprising a PLL oscillator that possesses an oscillator with plural circuit elements cascaded in multiple stages, compares the phase of a signal generated by the oscillator with the phase of the clock inputted to the first stage, and controls a voltage of a power supply line according to the phase comparison result, wherein:
the first delay line is connected to the common power supply line with the oscillator, and the circuits elements of the first delay line are equivalent to the circuit elements of the oscillator.

3. A recording pulse generator as claimed in claim 1 or claim 2, wherein the clock inputted to the first stage of the first delay line is an EFM clock that varies according to a recording speed.

4. A recording pulse generator as claimed in any of claim 1 through claim 3, wherein the clock selection means is a multiplexer controlled by selection signals shifted in the same phase with the fine clocks.

5. A recording pulse generator as claimed in any of claim 1 through claim 4, wherein the recording pulse generation means is provided with a flip-flop circuit that operates based on a delayed clock selected by the multiplexer.
